(19) United States
(12) Patent Application Publication
(10) Pub. No.: US 2017/0241156 A1
(43) Pub. Date: Aug. 24, 2017

(54) Hunting Blind and Method of Manufacturing the Same

(71) Applicant: Troy Earheart, Burleson, TX (US)

(72) Inventor: Troy Earheart, Burleson, TX (US)

(21) Appl. No.: 15/390,283

(22) Filed: Dec. 23, 2016

Related U.S. Application Data
(60) Provisional application No. 62/273,312, filed on Dec. 30, 2015.

(51) Int. Cl. E04H 15/00; E04B 1/343; B29C 44/56; A01K 97/01; E04H 15/58; B29C 44/02; E04B 1/348; A01M 31/02

(52) U.S. Cl. CPC E04H 15/001; E04B 1/34869; E04B 1/34336; A01M 31/025; A01K 97/01; E04H 15/58; B29C 44/02; B29C 44/569; B29C 44/5681; B29K 2075/00

(57) ABSTRACT

A portable structure or hunting blind includes a floor railing or frame system for supporting side walls and a roof. The side walls and roof are formed of polyurethane foam. The side walls and roof can be manufactured by applying uncured polyurethane foam over a sheeting material, which is supported by a removable set of forms. The polyurethane foam is then allowed to cure, and once cured the forms are removed. A door and windows and floor decking can then be installed to finish out the hunting blind. The exterior of the polyurethane foam walls and roof can be coated with an elastomer coating for UV protection.

### CROSS-REFERENCE TO RELATED APPLICATIONS AND PRIORITY CLAIM

This application claims priority to Provisional Application Ser. No. 62/273,312 filed Dec. 30, 2015, which is incorporated herein by reference for all purposes.

### BACKGROUND

1. Field of the Invention

The present application relates generally to portable structures that may be used as hunting blinds, and more specifically, to polyurethane hunting blinds.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 shows a front perspective view of a portable structure or hunting blind in accordance with an embodiment of the present application.

FIG. 2 shows rear perspective view of the hunting blind shown in FIG. 1.

FIG. 3 shows an interior view of the hunting blind shown in FIG. 1.

FIGS. 4A and 4B show a floor rail system for the hunting blind of the present application.

FIGS. 5A-5G show examples of forms that can be used for manufacturing the hunting blind of the present application.

FIG. 6 shows a front view of a partially-completed hunting blind of the present application.

FIG. 7 shows a view of an embodiment of a side wall of the hunting blind of the present application.

FIG. 8 shows a view of an installation process for installing a window frame into the hunting blind of the present application.

FIG. 9 shows a front perspective view of an alternative embodiment of the hunting blind of the present application.

FIG. 10 shows an interior view of the hunting blind shown in FIG. 9.

FIGS. 11A and 11B are perspective and enlarged perspective views, respectively, of a floor frame of an embodiment of the hunting blind of the present application.

FIGS. 12A through 12C are perspective views of portions of a form used to fabricate an embodiment of the hunting blind of the present invention.

FIGS. 13A through 13E are perspective views of the form of FIGS. 12A through 12C prepared for application of foam according to an embodiment of the hunting blind of the present application.

FIG. 14 is a perspective view of an embodiment of the hunting blind of the present application fabricated using the process and forms of FIGS. 11A through 13E.

FIG. 15 is a perspective view of a urinal fixture for use in an embodiment of the hunting blind of the present application.

While the apparatus and method of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the apparatus and method are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of the present application will be understood, both as to its structure and operation, from the accompanying drawings, taken in conjunction with the accompanying description. Multiple embodiments are presented herein. It should be understood that various components, parts, and features of the different embodiments may be combined together and/or interchanged with one another, all of which are within the scope of the present application, even though not all variations and particular embodiments are shown in the drawings. It should also be understood that the mixing of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

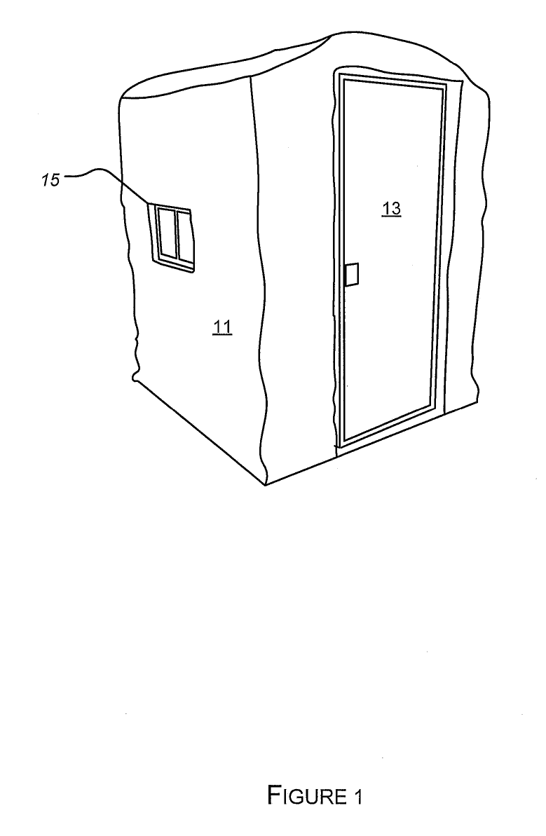

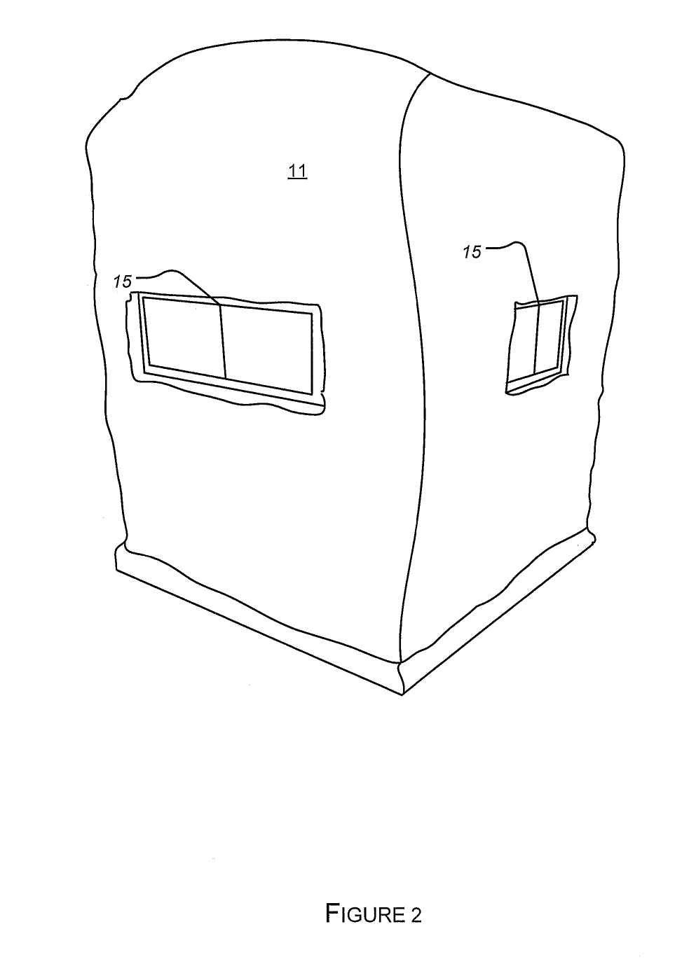

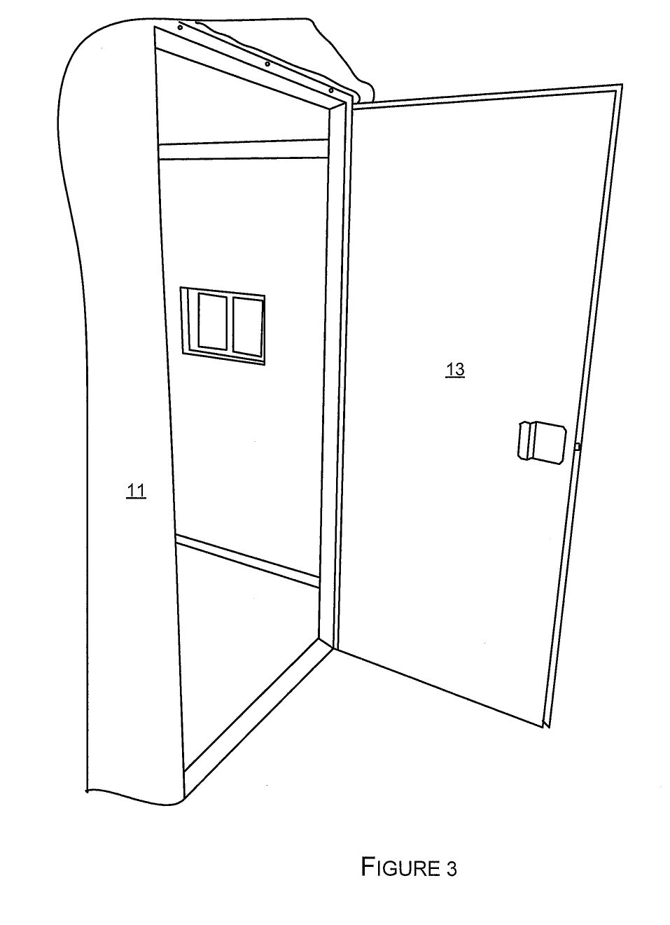

FIG. 1 shows a front perspective view of a portable structure that may be used as a hunting blind 11 in accordance with an embodiment of the present application, and FIG. 2 shows rear perspective view of the hunting blind shown in FIG. 1. Although the portable structure illustrated is contemplated for use as hunting blind, it is equally suitable for use wherever small, human-habitable structures find application. The terms “hunting blind” and “portable structure” are used synonymously and interchangeably herein. FIG. 3 shows an interior view of the hunting blind shown in FIG. 1. As shown, hunting blind 11 has a door 13 and windows 15.

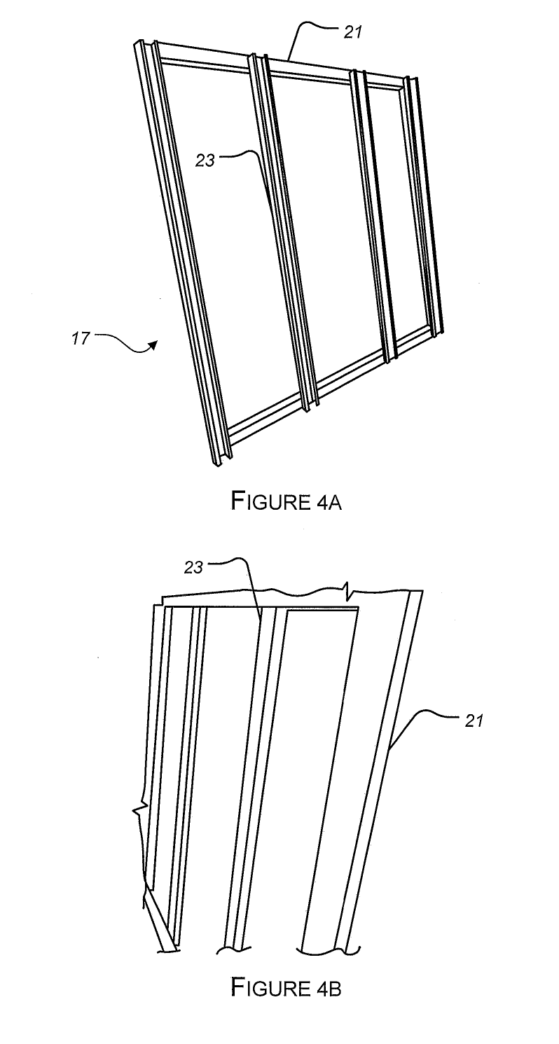

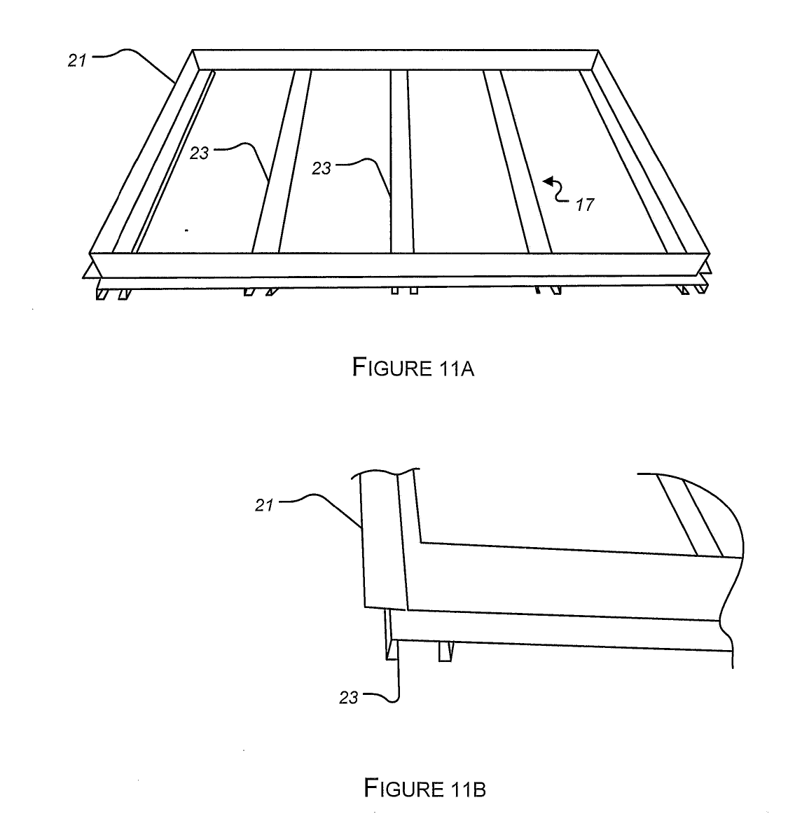

The hunting blind includes a floor railing system or frame 17 shown in FIGS. 4A and 4B (and also in FIGS. 11A and 11B), which includes an outer perimeter formed of steel, iron, aluminum, or other metal or polymer “angle iron” beams 21 and a plurality of cross-members formed of steel, iron, aluminum, or other metal or polymer “C-channel” beams. The floor railing system supports the side walls and roof of the hunting blind. The side walls and roof are formed of a foam material, which may be a polyurethane foam. The polyurethane foam is preferably a closed-cell foam, but may also be an open-celled or other foam insulating material. For example, the foam can be formed from a product that includes an “A” component (ISO) and a blended “B” component (RESIN), such as Foamsulate 50 sold by Premium Spray Products.

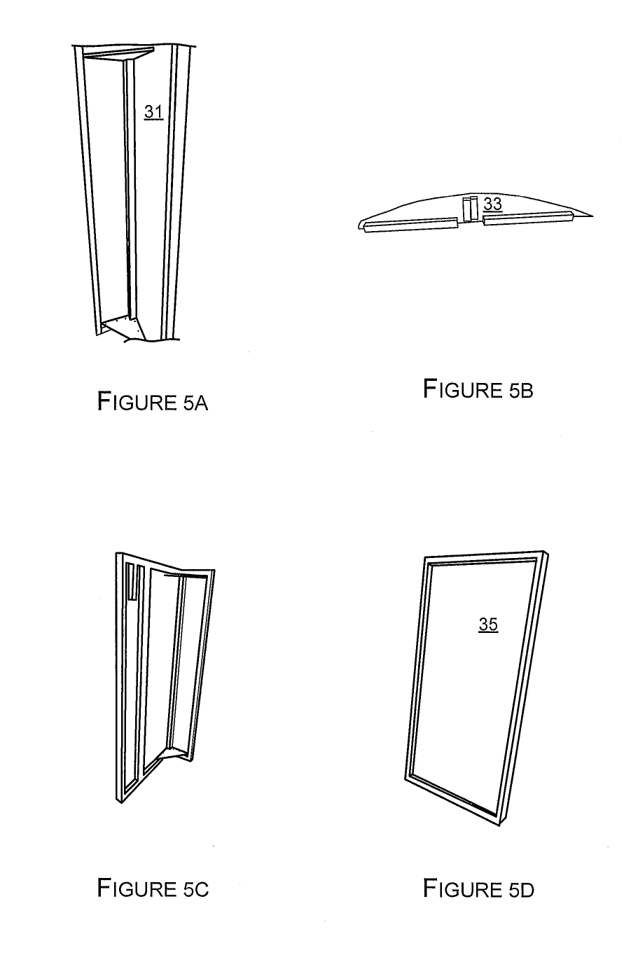

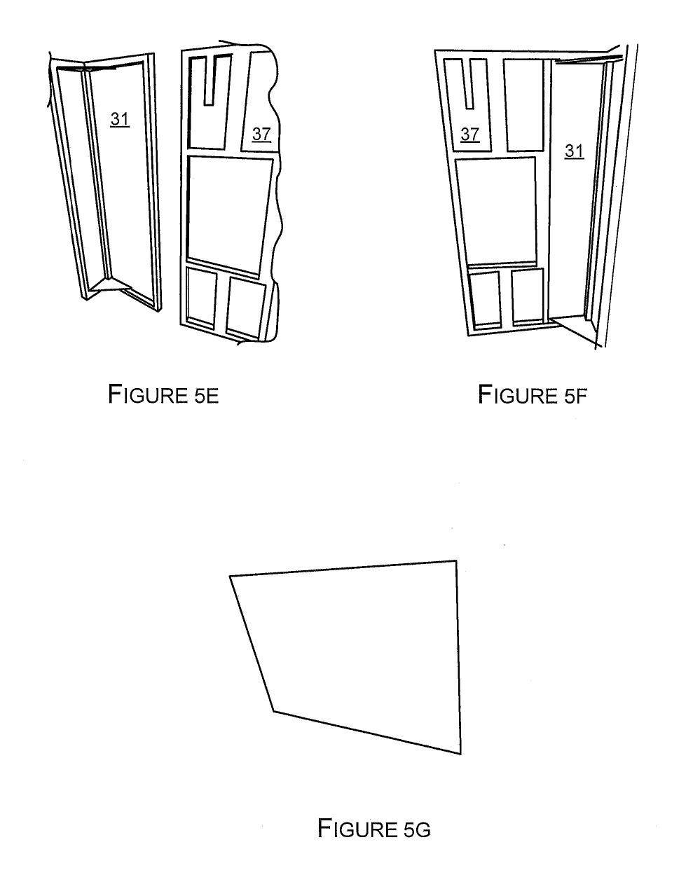

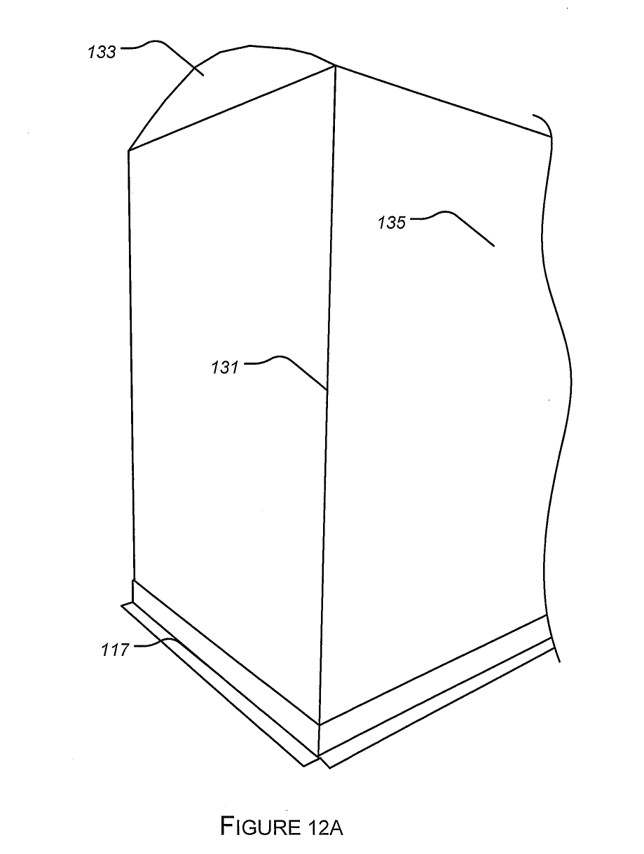

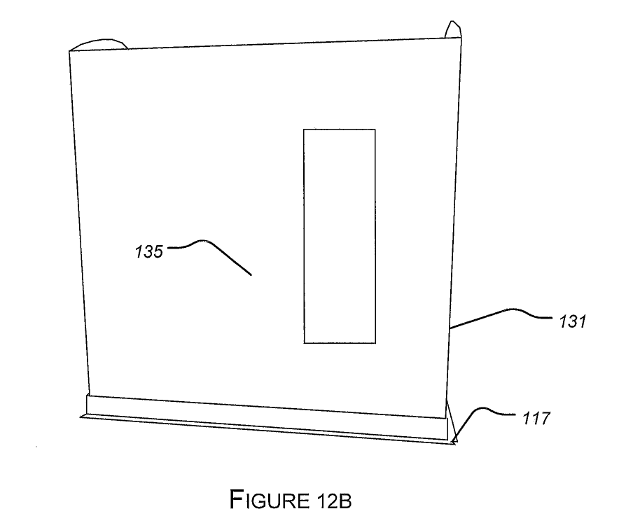

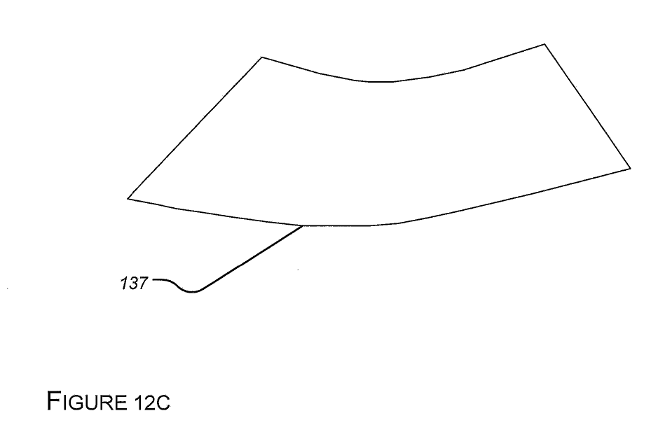

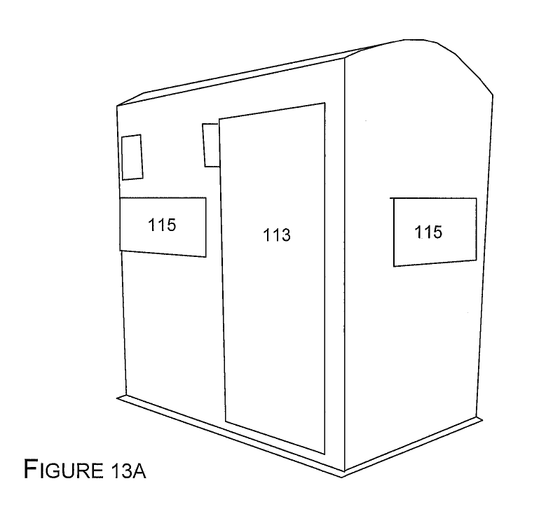

FIGS. 5A-5F show examples of forms that can be used for manufacturing the hunting blind of the present application, which may include corner sections 31, a roof bow 33 (see also FIG. 12C), flat wall sections 35, and wall sections 37 with openings for windows or doors. The forms may be made of wood rails and boards or plywood and may be assembled on the floor railing system so as to have an outer size and shape that matches a desired interior size and shape of the hunting blind. It will be appreciated that the forms may be made of other suitable materials, such as PVC and/or other polymeric materials. FIG. 5G shows a floor panel that is placed atop floor frame or railing system 17 to provide a floor. The exterior of the forms are then covered with a sheeting material, such as sheets of felt fabric or paper that is commonly used as a roofing underlayment. The exterior of the sheeting material is then sprayed with uncured foam material, which is then allowed to cure. The curing process of the foam material will cause the foam material to expand and harden. Once the foam material has fully cured, the forms can be removed from the interior of the hunting blind. After curing, the foam material is preferably about 2-2.5 inches thick.

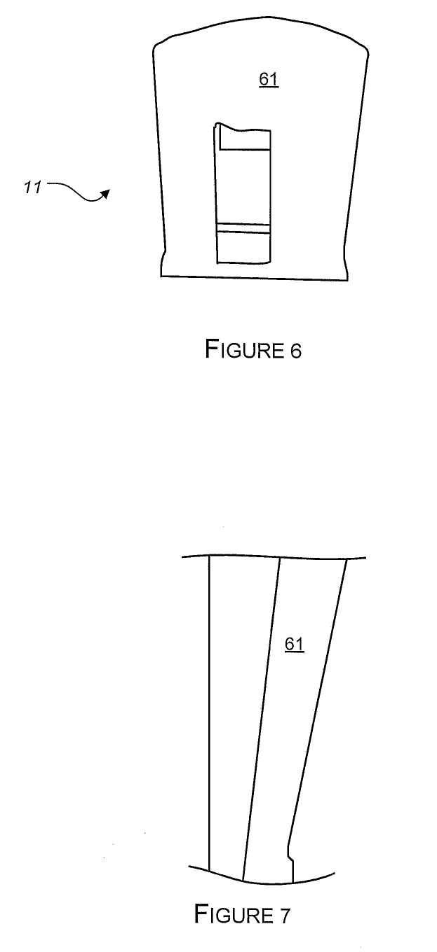

FIG. 6 shows a front view of a partially-completed hunting blind of the present application. In the view shown in FIG. 6, foam material 61 has cured and the forms have been removed. At this stage, holes for doors and windows can be cut, trimmed, and/or cleaned from the polyurethane side walls as desired, or can be formed by using openings in the forms before the forms are removed (this is the major difference from the fabrication method described in connection with FIGS. 11 through 15, below). FIG. 7 shows a view of an embodiment of a side wall of the hunting blind. As shown in FIG. 7, the side wall is formed primarily of the cured polyurethane foam, and the interior is lined with the sheeting material.

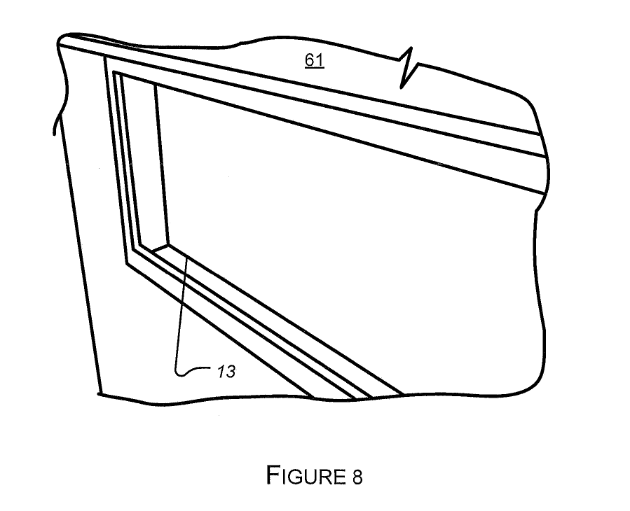

FIG. 8 shows a view of an installation process for installing a window 13 frame into the hunting blind. Once the side walls have cured and holes have been cut for doors and windows, frames can be installed for doors and windows as desired. The window and door frames can be attached directly to the foam side walls using screws and/or adhesive. Also, while not shown, the floor railing system can be covered by sheet metal and then by wood decking in order to provide a fully-contained interior space that is insulated and substantially insulated from the outside. Also, while not shown, additional legs or other types of support members can be provided under the hunting blind and attached to the floor railing system in order to support the hunting blind some desired distance above ground level. Also, the exterior of the hunting blind can be coated with an elastomeric coating, which can provide protection for the polyurethane side walls and roof from heat and from ultraviolet (UV) rays.

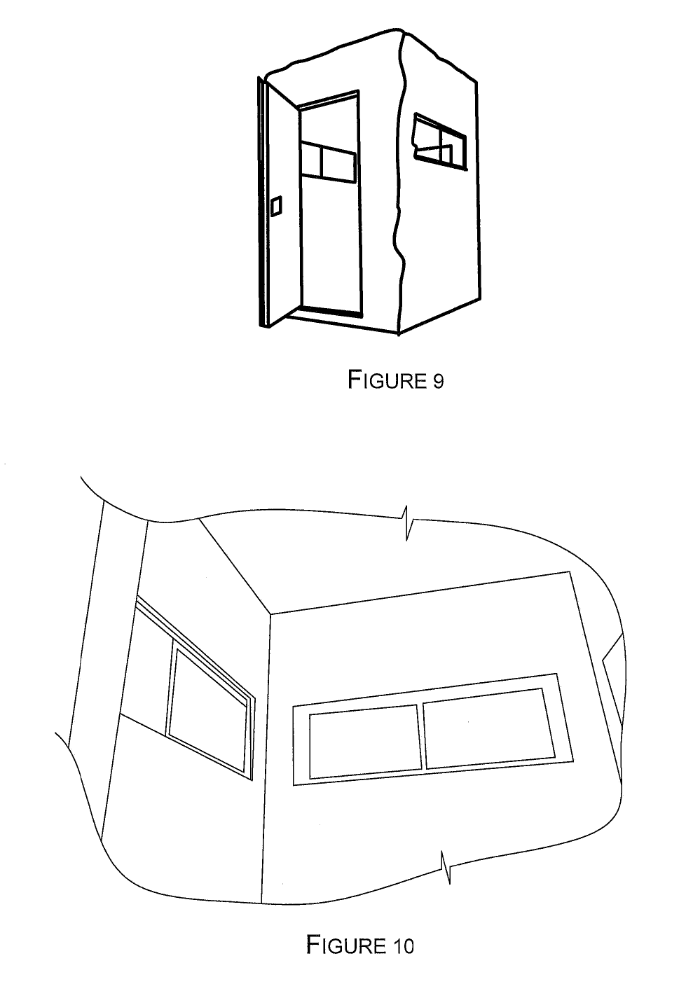

FIG. 9 shows a front perspective view of an alternative embodiment of the hunting blind of the present application, and FIG. 10 shows an interior view of the hunting blind shown in FIG. 9. The hunting blind shown in FIGS. 9 and 10 can be manufactured using the same process described above, except that the hunting blind shown in FIGS. 9 and 10 includes interior panels 81 on the side walls and ceiling. The interior panels can be attached to the polyurethane foam using screws and/or adhesive.

FIGS. 11 through 14 illustrate a different method of forming a hunting blind in accordance with another embodiment of the invention. This method differs from that described in connection with FIGS. 4 through 8 in that apertures or holes are not cut for windows and doors, rather, prefabricated windows and doors are “foamed-in-place,” as will be described.

FIGS. 11A and 11B are further depictions of floor frame 17 illustrating that the flanges of “angle iron” perimeter members 21 are turned outward to provide a support “shelf” for foam material. Also, it can be seen that c-channel cross-members 23 have their open sides downward. Preferably, a floor panel of at least ⅝-inch (0.625) plywood, sheet-metal, or a polymer sheet is coextensive with floor frame 17 and placed interior of perimeter members 21 to provide a floor for the hunting blind (see FIG. 5G). Floor frame 17 remains a part of the hunting blind 11 according to the invention.

As with the previously described method, upstanding wall forms are placed in flooring frame 17. However, according to the method of this embodiment of the invention, the forms comprise mostly or entirely corner sections 131, roof bows 133, and flat wall sections 135. Form sections are all dimensioned to be small enough to be removed through the door of the hunting blind after completion. Sections with apertures pre-formed are not necessary unless the hunting blind is to be provided with an open aperture (no window or door, as for a shooting port) or is to be fitted with a non-prefabricated window or door. Optionally, apertures may be provided under window locations to allow access to the window before, during, or after the application of foam and to assist in locating windows on the forms. FIGS. 12A through 12C illustrate these forms secured in floor frame 17. FIG. 12B illustrates a form assembly with an aperture in the forms. FIG. 12C illustrates a roof panel 137, which is formed of Masonite or similar material.

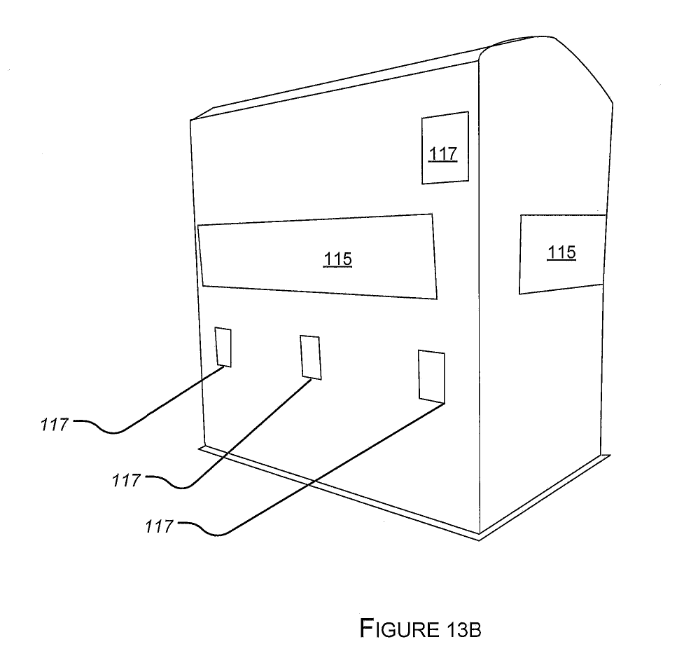

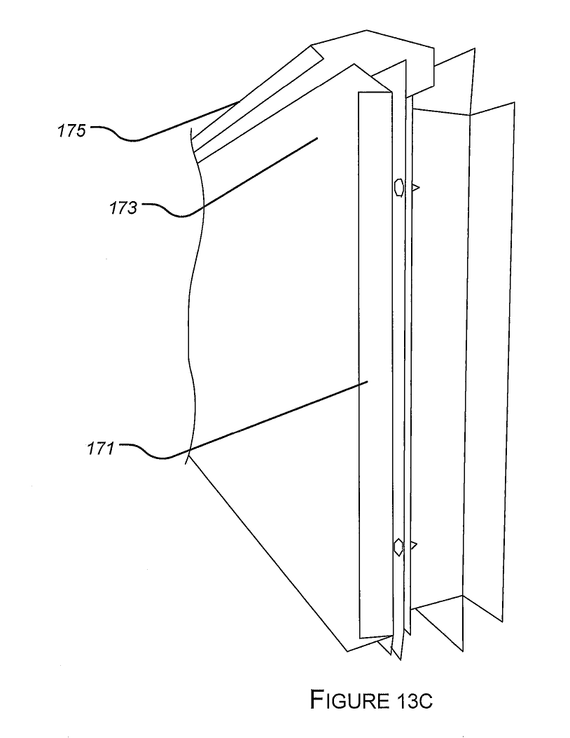

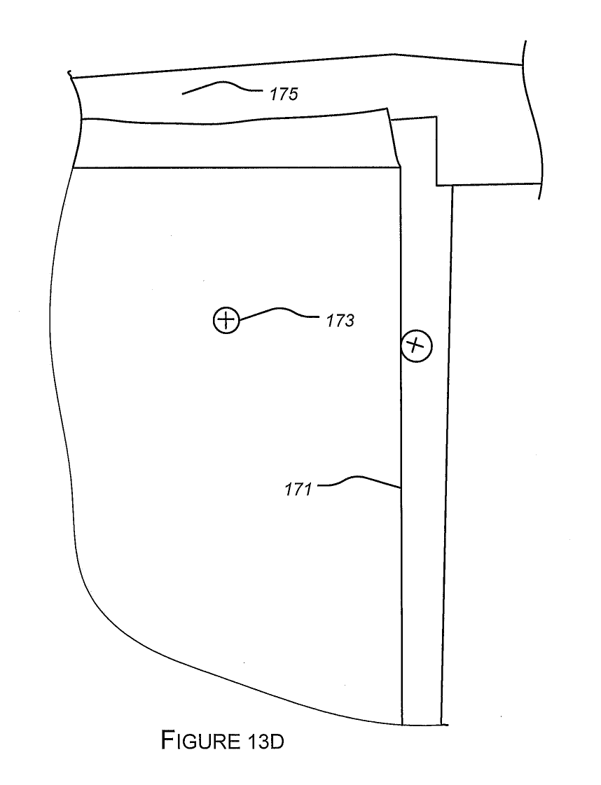

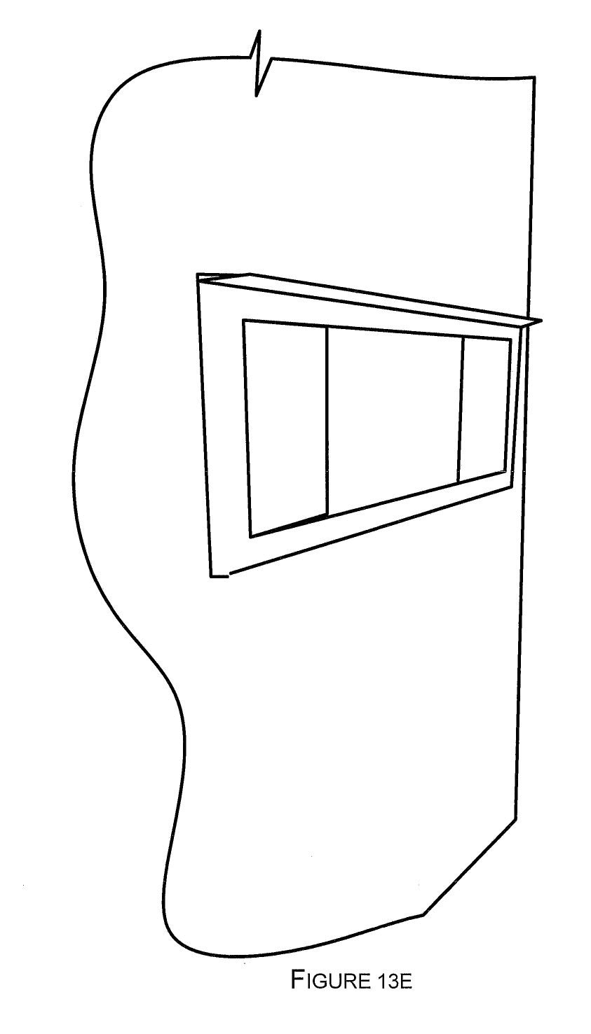

FIGS. 13A through 13E illustrate forms covered with fabric and with prefabricated windows and doors arranged prior to the application of foam to the structure. The fabric is preferably a spunbonded (non-woven) polyester geotextile fabric that is water-impermeable, preferably with a printed grid for ease of cutting to dimension. The fabric sheets that cover the ends of corner sections 131 and flat wall sections 135 are temporarily fixed to the underlying corner sections 131 and flat wall sections 135 with staples, tape, or other suitable means. The fabric sheet that extends over roof bow 133 is dimensioned to overlap the end sections by several inches at the corners and seams. The overlapped portions are preferably adhered to each other by a spray adhesive. As the forms are removed from the inside of the structure, the temporary staples pull through the fabric and are removed with the forms. The fabric provides a separation layer between the foam material and the forms, assisting with the removal of the forms. It also provides some structural integrity to the foam layer. In addition, the fabric is preferably ant-bacterial, anti-microbial, has fire-rated backing feature, and is impermeable to moisture, which makes is well suited to receive, stand up to, and hold the spray foam.

As shown in the Figures, prefabricated windows 115 and doors 113 (or their frames) are secured to the exterior of the forms and over the fabric in their desired locations. Additionally, structure panels 117 (FIG. 13B), of plywood or similar strong and rigid material are adhered by releasable glue to the exterior of the forms at selected locations. Structure panels 117 remain embedded in the foam material and provide points in the finished structure that are load-bearing and can receive fasteners such as nails or screws. Structure panels 117 may be used for mounting shelves and the like.

As shown in greater detail in FIGS. 13C and 13D, a prefabricated window or door is provided by placing the flashing of its frame against the fabric-covered form at the desired location. A sheet-metal cover 171, that is generally coextensive with the frame of the prefabricated window or door, is placed over the frame to prevent foam material from filling the frame. This assembly is secured on the form by screws 173 that extend through cover 171, through a stand-off, and into the plywood form. Screws 173 support and position the window or door frame on the form. A sheet-metal, preferably aluminum, shelf or ledge 175 may be placed at the top of window or door frame to provide a “drip ledge” upon fabrication of the structure. FIG. 13E shows a prefabricated window placed on the form with panes open prior to securing cover 171 in place through screws 173, which extend through the openings in the window. Because the portable structure is contemplated as a hunting blind, among other uses, windows and doors with quiet mechanisms are preferred, such as windows with felt sliders, as illustrated.

After the forms are assembled, the fabric is applied and the appropriate structure panels 117, windows 115, and doors 117 are placed on the forms. The foam material may then be applied, preferably by spraying. When the foam material has been applied to the desired thickness, preferably 2-2.5 inches, it is permitted to set and cure. After curing, screws 173 and covers 171 may be removed, exposing the prefabricated windows and doors, or their frames. Then the forms are removed from the interior of the structure through the windows or doors.

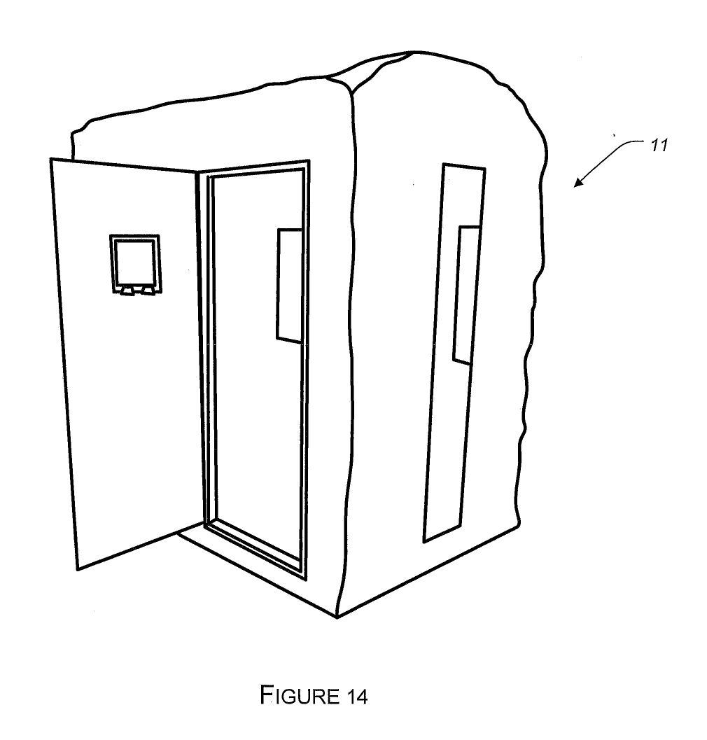

FIG. 14 depicts a completed portable structure fabricated in accordance with the method disclosed. The drip ledges are visible above the windows and doors. Various paints, sealants, protective coatings, and colors may be applied for aesthetic, camouflage, and/or certain functional purposes. For example, a roofing polymer, such as the product available under the brand name Uniflex 41-30A, may be used to provide a durable, water-repellent, and UV-protective finish. Such material may be rolled and/or sprayed onto the finished structure. Polyurea-based elastomer coatings are another option, which can be sprayed on, and have even better durability, while offering the same levels of protection.

The result of both methods or processes of fabrication is a lightweight, well-insulated portable structure having integrally formed or foamed or cast-in-place walls and roof. The walls and roof are seamless except for any windows and doors or other apertures intentionally formed.

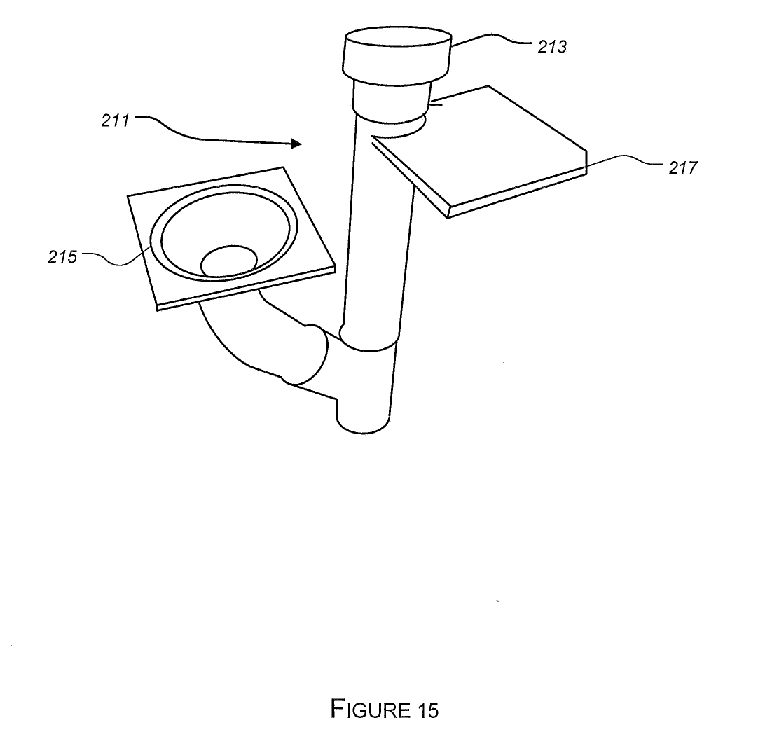

FIG. 15 illustrates a urinal 211 constructed of PVC sewer pipe adapted for use in the structures according to the invention. Urinal 211 has an upper opening 213 adapted for use by adult men and a lower opening 215 adapted for use by women and children. The lower end of urinal 211 extends through an opening formed in the floor panel and may extend to the ground or even underground, depending upon the permanence of the location. Urinal 211 is provided with a plywood or particle board flange 217, which is configured to be secured in a corner of portable structure 11 to appropriate structure panels 117 by brackets and screws or nails, or even adhesive. Urinal 211 thus provides a conduit to carry waste out of the interior of structure 11.

Although not shown, it is also contemplated that the exterior of the hunting blind can be provided with various aesthetic features, such as colors, designs, textures, and embossing, particularly various camouflaging patterns and colors, as well as, various functional features, such as lights, solar systems, cameras, data transmission systems, reflectors, locks, and ladders. It will be appreciated that structure 11 may include certain stabilizing features, such as tie-downs, guy-wires, and anchor systems. Also, the interior of the hunting blinds can be provided with a variety of implements, such as seats, shelves, lighting, heaters and AC systems, a urinal and/or a toilet. In some embodiments, the floor can be provided with a trap door that can be opened, so that the hunting blind can be used as an ice-fishing shelter. An air-conditioner can be provided, which may operate the structure as a walk-in cooler, due it its small size and well-insulated character. The portable structure fabricated as disclosed should have an “R” value of about 20 and weigh about 250 pounds or less for a 5 foot by 8 foot structure.

It will be appreciated that the portable structure of the present applicant may be readily adapted for use as a duck blind, in which case, one or more of the walls and/or roof could be modified to better facilitate duck hunting. In addition, in the duck blind embodiment, the structure may include pontoons or other floatation devices that allow the structure to be used on or near a body of water. The duck blind may include exterior platforms for hunting dogs to rest upon, and one or more dog doors to allow dogs to enter and exit the structure. In addition, one or more small doors or windows may be provided to allow a dog to place a retrieved water fowl into the structure without the dog fully entering the structure.

The portable structure may be provided with a variety of base structures connected to the underside of the structure via the open c-channels of the floor rail assembly. The base structure may form a universal attachment system for attaching extension systems of various heights, thereby adding to the modular nature of the overall system. The base may be of varying height and configuration, or the portable structure can sit directly on the ground (or ice as in the case of an ice-fishing shelter).

It is apparent that a system and method with significant advantages has been described and illustrated. The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

I claim:

1. A portable, human-habitable structure, comprising:
a rigid floor frame with a floor;
at least a pair of integrally formed walls upstanding from the rigid floor frame; and
a roof integrally formed with the upstanding walls.

2. The structure of claim 1, wherein the walls and roof are integrally formed of polyurethane foam.

3. The structure of claim 1, further comprising:
a door received in an aperture formed in one of the walls.

4. The structure of claim 3, further comprising:
a window received in an aperture formed in one of the walls.

5. The structure of claim 1, wherein the rigid floor frame comprises:
a generally rectangular perimeter frame formed of angle iron;
a plurality of C-channel cross members spanning opposing sides of the perimeter frame.

6. The structure of claim 5, further comprising:
a floor sheet generally coextensive with the perimeter frame.

7. The structure of claim 6, further comprising:
a urinal conduit extending through the floor sheet to carry waste exterior of the structure.

8. The structure of claim 6, further comprising:
an opening in the floor sheet to access the exterior of the structure for ice fishing.

9. A method of fabricating a portable structure comprising:
constructing a rigid floor frame;
molding at least a pair of walls upstanding from the floor frame and a roof connecting the walls above the floor frame.

10. The method of claim 9, further comprising:
forming a door aperture in at least one of the walls during the molding step.

11. The method of claim 9, further comprising:
forming a window aperture in at least one of the walls during the molding step.

12. The method of claim 9, further comprising:
securing upstanding wall forms to the floor frame and a roof form connecting the wall forms.

13. The method of claim 12, wherein the molding step comprises:
spraying polyurethane foam over the wall and roof forms.

14. The method of claim 13, further comprising:
removing the wall and roof forms after the polyurethane foam has cured.

15. The method of claim 12, further comprising:
securing a window frame to one of the wall forms; and
securing a door frame to one of the wall forms.

16. The method of claim 12, further comprising:
securing at least one structure plate to one of the wall forms.

17. The method of claim 13, further comprising:
applying a sheeting material to the wall and roof forms before the step of spraying polyurethane foam over the forms.
